(19) United States
(12) Patent Application Publication
(10) Pub. No.: US 2023/0230167 A1
(43) Pub. Date: Jul. 20, 2023

(54) Insurance Actuarial Engine

(71) Applicant: ActuaViz Co., Ltd., Taipei City (TW)

(72) Inventor: Chih-Hsiang Chiang, Taipei City (TW)

(73) Assignee: ActuaViz Co., Ltd., Taipei City (TW)

(21) Appl. No.: 17/575,710

(22) Filed: Jan. 14, 2022

(51) Int. Cl. G06Q 40/08; G06Q 30/02

(52) U.S. Cl. CPC G06Q 40/08; G06Q 30/0201

(57) ABSTRACT

An insurance actuarial engine mainly includes an asset-liability module, an economic scenario module, and an actuarial analysis module. The asset-liability module generates cash flow data after state conversion of input asset data, and imports the cash flow data into the economic scenario module. The economic scenario module performs a hypothetical actuarial procedure based on future economic scenarios to generate corresponding relationships of actuarial models. Finally, the cash flow data and the generated actuarial models and their corresponding relationships are then imported into the actuarial analysis module to generate various actuarial indicators and their estimates. Through a series of automated and normalized calculations, the corresponding actuarial models and various indicators are quickly constructed.

### FIELD OF THE INVENTION

The present disclosure relates to an actuarial framework, and more particularly to an insurance actuarial engine built in a normalized way.

### BACKGROUND OF THE INVENTION

In recent years, in response to the increasing demand for financial security and financial internationalization, more and more actuarial models and standards need to be made. For example, the International Financial Reporting Standards (IFRS 17) and the attached VM-21 standards for certifying of payment of variable annuity insurance require more rigorous calculations and a greater amount of calculations than ever.

Meanwhile, with the continuous and vigorous development of financial technology innovation, the wave of opening banking rises, and the core purpose is to enable the public to obtain financial services and commodities through a more convenient and affordable way. However, the development of opening insurance is relatively slow, and one of the reasons is that the implementation of insurance commodities needs to rely on a large number of actuarial professional manpower supports.

In practice, the Society of Actuaries (SOA) and the National Association of Insurance Commissioner (NAIC) have established a complete set of actuarial operation processes and standards, which are mainly implemented using Microsoft Excel software, so that a lot of calculations cannot be afforded. Even with the assistance of specialized actuarial software, it is still difficult to operate practically, and it is necessary to take a lot of time to learn background knowledge.

Therefore, the inventors want to make the structure of actuarial models more concise and clear through the normalized design, and to quickly generate an actuarial cash flow, which is the trend of the times. In addition to greatly solving the current dilemma, it will bring major changes and industrial upgrading for actuarial insurance work processes.

### SUMMARY OF THE INVENTION

In view of the above deficiencies, a main object of the present disclosure is to provide an insurance actuarial engine that allows a user to quickly construct an actuarial model and concatenate data through a normalized design using an actuarial model framework created by the present disclosure.

In order to achieve the above object, the present disclosure is directed to an insurance actuarial engine, mainly including an asset-liability module, an economic scenario module, and an actuarial analysis module. The asset-liability module generates cash flow data after state conversion of input asset data, and imports the cash flow data into the economic scenario module. The economic scenario module performs a hypothetical actuarial procedure based on future economic scenarios to generate corresponding relationships of actuarial models. Finally, the cash flow data and the generated actuarial models and their corresponding relationships are then imported into the actuarial analysis module to generate various actuarial indicators and their estimates. Through a series of automated and normalized calculations, the corresponding actuarial models and various indicators are quickly constructed.

In order to make the above and other objects, features and advantages of the present disclosure more clearly understood, preferred embodiments are exemplified below, and are described in detail as follows in conjunction with the accompanying drawings.

### BRIEF DESCRIPTION OF THE DRAWINGS

FIG. 1 is a structural diagram of an insurance actuarial engine according to the present disclosure.

FIG. 2 is a block diagram of an asset-liability module according to the present disclosure.

FIG. 3 is a block diagram of an economic scenario module according to the present disclosure.

FIG. 4 is a block diagram of an actuarial analysis module according to the present disclosure.

### DETAILED DESCRIPTION OF THE EMBODIMENTS

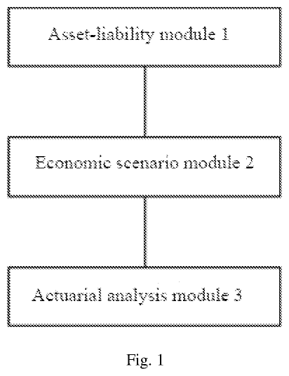

Referring to FIG. 1, a structural diagram of an insurance actuarial engine according to the present disclosure is shown. As shown in the figure, the insurance actuarial engine according to the present disclosure mainly includes an asset-liability module 1, an economic scenario module 2, and an actuarial analysis module 3. The asset-liability module 1 generates cash flow data after state conversion of input asset data, and imports the cash flow data into the economic scenario module 2. The economic scenario module 2 performs a hypothetical actuarial procedure based on future economic scenarios to generate corresponding relationships of actuarial models. Finally, the cash flow data and the generated actuarial models and their corresponding relationships are then imported into the actuarial analysis module 3 to generate various actuarial indicators and their estimates. Through a series of automated and normalized calculations, the corresponding actuarial models and various indicators are quickly constructed. In the present embodiment, the definition of normalization refers to resolving an actuarial model and data into several items, such as states, factors, parameters, tables, functions, modules, processes, and products, to normalize the stream of data input and output.

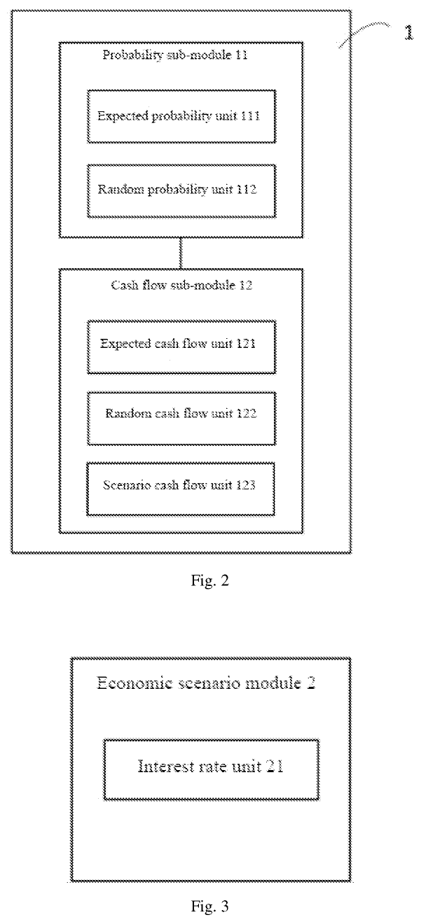

Referring to FIG. 2, a block diagram of an asset-liability module according to the present disclosure is shown. Various functions and processes of the modules covered by the aforementioned data engine will be described in detail. As shown in the figure, the asset-liability module 1 establishes a cash flow model for asset data. In the present embodiment, the asset data refers to an asset such as, but not limited to, an insurance policy, a mobile phone, a car, etc. which is purchased by an insurer, or a liability such as, but not limited to, an insurance policy, a credit, a house loan, etc. which is sold by an insurance company. The asset-liability module 1 further includes a probability sub-module 11 and a cash flow sub-module 12. The probability sub-module 11 additionally includes an expected probability unit 111 and a random probability unit 112. The probability sub-module 11 is used to establish a state conversion probability of “each time point in the future” for the asset data. The conversion probability time may be a discrete time period (e.g. yearly, quarterly, monthly, daily, or user-defined period) or continuous time points. The expected probability unit 111 and the random probability unit 112 respectively provide different probability calculation modes to meet different analysis requirements. The expected probability unit 111 is used to generate a set of probability values calculated with expected values. The random probability unit 112 generates a plurality of sets of random variables by a Monte Carlo method.

With continued reference to FIG. 2, the cash flow sub-module 12 is electrically connected to the probability sub-module 11 for receiving probability expected value data generated by the probability sub-module 11 to perform subsequent calculations. The cash flow sub-module 12 is used to establish a cash flow state of “each time point in the future”. The cash flow sub-module 12 further includes an expected cash flow unit 121, a random cash flow unit 122 and a scenario cash flow unit 123. The expected cash flow unit 121 and the random cash flow unit 122 generate expected cash flow or random cash flow data in combination with the aforementioned expected probability unit 111 and random probability unit 112. The expected cash flow unit 121 defines how a cash flow of a scenario is generated in a normalized way. The scenario is referred to herein as a cash flow scenario of “each state” or “each state conversion time” at “each time point in the future”, such as expenditure or income.

Referring to FIG. 3, a block diagram of an economic scenario module according to the present disclosure is shown. As shown in the figure, the economic scenario module 2 is electrically connected to the asset-liability module 1 for receiving the cash flow data calculated by the asset-liability module 1 for subsequent calculations. The economic scenario module 2 is used to perform hypothetical actuarial calculation on a “future economic scenario”, and automatically establish corresponding relationships of actuarial models by using company experience data or government public data as economic scenario parameters. The economic scenario module 2 further includes an interest rate unit 21. The interest rate unit 21 provides a fixed interest rate or a scenario interest rate for the selection of different scenarios, and further uses the definition of a time factor, in combination with a time axis algorithm, to automatically correct and concatenate a time point of an asset-liability cash flow, calculate a result, and establish a CDMN base table as an analysis tool for a subsequent operator after an automatic procedure is completed. In the present embodiment, the economic scenario as described herein refers to a future hypothesis on actuarial calculation, which is generally based on a bond yield (but not exclusively) in combination with different interest rate models for algorithms, such as an economic scenario generator published by the SOA. In addition, a basic calculation formula of the CDMN base table includes:

C_{z}=v^{x+1}·dₓ

Dₓ=vₓ·lₓ

Mₓ=Cₓ+Cₓ₊₁+ . . . +C_{w}

Nₓ=Dₓ+Dₓ₊₁+ . . . +D_{w-1}

where C refers to the number of deaths at different ages, considering the current value of an interest rate discounted to 0 years-old, it refers to the number of survivors at different ages, considering the current value of the interest rate discounted to 0 years-old, M is a cumulative value of C at each age, N is a cumulative value of D at each age, x is an age, v is a discounting rate, dx is the number of deaths at that age, lx is the number of survivors at that age, and w is a life table termination age. The required CDMN base table may be automatically generated by specifying a calculation time axis and a state conversion probability, so that the established actuarial model may be extended from month as the calculation basis of time to day as the calculation basis of time.

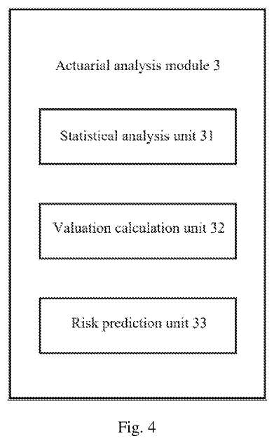

Referring to FIG. 4, a block diagram of an actuarial analysis module according to the present disclosure is shown. As shown in the figure, the actuarial analysis module 3 according to the present disclosure is electrically connected to the economic scenario module 2 for receiving the aforementioned cash flow data for subsequent analysis and data output of the corresponding CDMN base table. The actuarial analysis module 3 further includes a statistical analysis unit 31, a valuation calculation unit 32 and a risk prediction unit 33. The statistical analysis unit 31 is a basic statistical analysis tool. The statistical analysis unit 31 uses a formula established by any one of, e.g. an average value, a variable, a quartile, etc. to perform the analysis on the cash flow data, but the tool type is not limited to this. The valuation calculation unit 32 is used to evaluate the value of the cash flow data. The valuation calculation unit 32 performs valuation by a formula established by any one of, e.g. but not limited to, net present value or Internal Rate of Return (IRR). Finally, the risk prediction unit 33 is used to evaluate a risk control indicator of the cash flow data. In the present embodiment, the risk prediction unit 33 performs risk prediction by using a formula established by any one of, e.g. but not limited to, Risk-Based Capital (RBC) or solvency II.

While the above implementations are preferred embodiments, the scope of implementation of the present disclosure cannot be limited thereto, and any equivalent changes or modifications made in accordance with the scope of patent application and the description of the present disclosure should all belong to the following patent coverage of the present disclosure.

### DESCRIPTION OF SYMBOLS

Asset-liability module 1
Probability sub-module 11
Expected probability unit 111
Random probability unit 112
Cash flow sub-module 12
Expected cash flow unit 121
Random cash flow unit 122
Scenario cash flow unit 123
Economic scenario module 2
Interest rate unit 21
Actuarial analysis module 3
Statistical analysis unit 31
Valuation calculation unit 32
Risk prediction unit 33

1. An insurance actuarial engine, comprising:
an asset-liability module, configured to establish a cash flow model for asset data, the asset-liability module further comprising:
a probability sub-module, configured to establish a state conversion probability of each time point in the future for the asset data, the probability sub-module further comprising:
an expected probability unit, configured to generate a set of probability values calculated with expected values; and
a random probability unit, configured to generate a plurality of sets of random variables; and
a cash flow sub-module, electrically connected to the probability sub-module for receiving probability expected value data generated by the probability sub-module to perform subsequent calculations, and configured to establish a cash flow state of each time point in the future, the cash flow sub-module further comprising:
an expected cash flow unit, configured to generate expected cash flow data in correspondence to the expected probability unit;
a random cash flow unit, configured to generate random cash flow data in correspondence to the random probability unit; and
a scenario cash flow unit, the expected cash flow unit defining how a cash flow of a scenario is generated in a normalized way;
an economic scenario module, electrically connected to the asset-liability module for receiving the cash flow data calculated by the asset-liability module for subsequent calculations, and configured to perform hypothetical actuarial calculation on a “future economic scenario”, the economic scenario module further comprising:
an interest rate unit, configured to provide a fixed interest rate or a scenario interest rate for the selection of different scenarios, and establish a CDMN base table after an automatic procedure is completed; and
an actuarial analysis module, electrically connected to the economic scenario module for receiving the aforementioned cash flow data for subsequent analysis and the corresponding data output, the actuarial analysis module further comprising:
a statistical analysis unit, serving as a basic statistical analysis tool for cash flow data analysis;
a valuation calculation unit, configured to evaluate the value of the cash flow data; and
a risk prediction unit, configured to evaluate a risk control indicator of the cash flow data.

2. The insurance actuarial engine of claim 1, wherein the conversion probability time of each time point in the future is any one of a discrete time period or continuous time points.

3. The insurance actuarial engine of claim 1, wherein the random probability unit generates a plurality of sets of random variables by a Monte Carlo method.

4. The insurance actuarial engine of claim 1, wherein the scenario is referred to in the scenario cash flow unit as a cash flow scenario of each state or each state conversion time at each time point in the future.

5. The insurance actuarial engine of claim 1, wherein the valuation calculation unit performs valuation by a formula established by any one of net present value or Internal Rate of Return (IRR).

6. The insurance actuarial engine of claim 1, wherein the risk prediction unit performs risk prediction by using a formula established by any one of Risk-Based Capital (RBC) or solvency II.

7. The insurance actuarial engine of claim 1, wherein the statistical analysis unit 31 performs data analysis by using a formula established by any one of an average value, a variable, a quartile, etc.
